(19) United States
(12) Patent Application Publication
(10) Pub. No.: US 2010/0314572 A1
(43) Pub. Date: Dec. 16, 2010

(54) Magnetorheological composite materials comprising hard magnetic particles, method for the production thereof and use thereof

(75) Inventors: Holger Bose, Wurzburg (DE); Andreas Hesler, Wurzburg (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: FRAUNHOFER-GESELLSCHAFT ZUR FORDERUNG DER ANGEWANDTEN FORSCHUNG E.V., Munchen (DE)

(21) Appl. No.: 12/665,570

(22) PCT Filed: Jun. 18, 2008
(86) PCT No.: PCT/EP08/04902

§ 371 Date: Sep. 2, 2010

(30) Foreign Application Priority Data
Jun. 21, 2007 (DE) 10 2007 028 663.7

(51) Int. Cl. H01F 1/26; C09K 3/14; B24B 1/00

(52) U.S. Cl. 252/62.54; 51/298; 451/28

(57) ABSTRACT

The present invention relates to composites comprising an elastic and/or thermoplastic-elastic carrier medium and hard magnetic particles which are polarised in a magnetic field, a magnetisation remaining after switching off the magnetic field.

The present invention relates to composites comprising an elastic and/or thermoplastic-elastic carrier medium and hard magnetic particles which are polarised in a magnetic field, a magnetisation remaining after switching off the magnetic field.

Magnetically controllable elastomer composites, so-called magnetorheological elastomers (MRE), are already known in a general form. Very much more widespread are magnetorheological fluids (MRF) in which the magnetisable particles are distributed in a carrier fluid. Because of the lack of chemical crosslinking, such materials have however no solid form but are liquid or deformable irreversibly as gels.

The possibility is likewise known of producing a chain-like arrangement of the particles in an MRE during crosslinking by applying a magnetic field. For this purpose, to date predominantly silicones which were used as castable precursors have been used. In addition, the use of other technically widespread elastomers made of natural and synthetic rubber, such as e.g. nitrile rubber, was described. Also the use of various magnetic particle materials in MRE was already mentioned in a general form.

It is thereby common to all the already known systems that always soft magnetic particles are used. Hence, only those materials are known, the permanent influencing of the mechanical properties of which requires the permanent presence of an external magnetic field. This is either complex from an apparatus point of view since for example an additional permanent magnet must be used in the respective device.

It is hence the object of the present invention to make available magnetorheological composites in which a permanent mechanical reinforcement of the composite matrix is made possible by the magnetic materials.

This object is achieved with respect to the composite materials with the features of claim 1 and, with respect to the object for producing the materials, with the features of claim 28. The dependent claims thereby represent respectively preferred embodiments. Purposes of use of the materials are mentioned in claims 39 to 42.

According to the invention, magnetorheological materials, comprising at least one non-magnetisable elastomeric and/or thermoplastic-elastic carrier medium and, contained therein, at least one first sort of magnetisable particles, are hence made available, the magnetisable particles being formed from at least one hard magnetic material. According to the invention, there are understood by hard magnetic materials such materials as are defined in the standard DIN IEC 60405-8-1. By means of the composite materials according to the invention, for example an embodiment is hence made possible, in which the basic rigidity of the composite can be permanently increased by the magnetisation of the hard magnetic particles. The magnetisation of the hard magnetic particles is effected for example by a briefly applied strong magnetic field of an electromagnet. This confers the advantage that, in contrast to a magnetorheological elastomer composite with soft magnetic particles, the magnetic field need not be maintained in order to retain the basic rigidity of the elastomer composite. By means of the only briefly required magnetisation current in the coil producing the field, the required energy supply is drastically reduced. On the other hand, by means of a subsequently temporarily applied magnetic field of a changed field strength and/or field direction, the hard magnetic particles can be permanently remagnetised, as a result of which a changed permanent basic rigidity of the elastomer composite is obtained. In this way, the mechanical properties of the elastomer composite, such as modulus of elasticity and shear modulus, can be switched between different stages by briefly applied magnetic fields. The softest stage of the elastomer composite is produced by demagnitisation of the hard magnetic particles. By means of the elastomeric and/or thermoplastic-elastomeric carrier media, the composite materials according to the invention are distinguished from plastic material-bonded magnets.

It is thereby advantageous if the remanence Bᵣ (measured according to DIN IEC 60404-5) of the hard magnetic materials thereby used is at least 50 mT, preferably at least 150 mT, particularly preferred at least 350 mT. It is hence ensured that the materials which are used have a high magnetisation capacity. The indicated values thereby relate to the regulation according to DIN TEC 60404-5 on materials themselves from which then the required particles or powders are produced.

The hard magnetic materials are in particular thereby selected from the group consisting of alloys based on Al—Ni—Co, Al—Ni—Co—Fe—Ti, Cr—Fe—Co, Fe—Co—V—Cr, Pt—Co, Cu—Ni—Fe, rare-earth compounds, such as RE-Co, RE-Fe—B, RE-Fe—N, RE=Sm, Ce, Pr, Nd and/or Dy, e.g. Nd—Fe—B, Nd—Pr—Fe—Co—Ti—Zr—B, Pr—Fe—Co—Nd—B, Sm—Fe—N; hard ferrites, preferably according to the formula M¹O.n Fe₂O₃, M¹=Ba, Sr and/or Pb and preferably 4.5≦n≦6.5 and also mixtures and/or alloys hereof. The indicated notation (“—”) respectively always comprises all possible compositions for the individual elements. In the mentioned alloys, also variants are included by the formulation “based on”, in which variants not all of the mentioned elements are contained, i.e. also the stoichiometric factor 0 is possible for individual elements.

The mentioned alloys should thereby be understood such that the content of the respective elements can be varied according to the desired properties of the material which are to be set. This measure is known to the person skilled in the art for example from the DIN standard IEC 60404-8-1, the entire disclosure content of which for the mentioned alloys is herewith contained by reference. Likewise, the mentioned alloys are not restricted to the explicitly indicated components, instead they can also contain further elements, e.g. Cu, Ti, Ni, Si, Fe, Mo, Al, V, Zr, Hf, Ga. Such alloys are likewise known in DIN IEC 60404-8-1 and are jointly contained by reference.

Preferred rare-earth compounds are thereby selected from the group consisting of Nd—Fe—B, Nd—Pr—Fe—Co—Ti—Zr—B, Pr—Fe—Co—Nd—B, Sm—Co and/or the alloys thereof.

It can thereby be desirable if hard magnetic particles represent the only sort of magnetic particles which are contained in the composite materials.

Furthermore, the invention likewise relates to composites comprising an elastic carrier medium and a mixture of hard magnetic and soft magnetic particles. In this case, when applying a strong magnetic field, a permanent magnetisation is produced due to the hard magnetic particles, whilst the magnetisation due to the soft magnetic particles disappears upon switching off the magnetic field. In this way, a material is produced, the mechanical properties of which—similarly to the previously known magnetorheological elastomers with exclusively soft magnetic particles—can be changed reversibly by a relatively weak magnetic field which does not influence the magnetisation of the hard magnetic particles. As a function of the direction of this relatively weak magnetic field relative to the premagnetisation of the hard magnetic particles, the overall magnetisation resulting from both types of particles, relative to the premagnetisation, can be either increased or weakened. As an effect thereof, the mechanical properties of such elastomer composites, such as modulus of elasticity and shear modulus, are reversibly increased or reduced. If in contrast a strong magnetic field is applied which changes the magnetisation of the hard magnetic particles, then also a permanent change in the magnetisation of the material is hence achieved.

Preferably, the soft magnetic particles are thereby formed from soft magnetic, metallic materials, in particular from iron, cobalt, nickel (also in an impure form) and alloys thereof, such as iron-cobalt, iron-nickel; magnetic steel; iron-silicon and/or mixtures thereof.

Alternatively thereto, it is however also possible that the soft magnetic particles are formed from soft magnetic oxide-ceramic materials, in particular from cubic ferrites, perovskites and garnets of the general formula

M²O.Fe₂O₃

having one or more metals from the group M²=Mn, Fe, Co, Ni, Cu, Zn, Ti, Cd or Mg and/or mixtures thereof.

A further preferred embodiment provides that the soft magnetic particles are formed from mixed ferrites, such as Mn—Zn—, Ni—Zn—, Ni—Co, Ni—Cu—Co—, Ni—Mg—, Cu—Mg ferrites and/or mixtures thereof.

However, it is likewise possible that the soft magnetic materials are formed from iron carbide or iron nitride and also from alloys of vanadium, tungsten, copper and manganese and/or mixtures thereof.

The soft magnetic particles used according to the invention can be present thereby in pure form, impure form and/or as mixtures.

Preferably, the average particle size of the first sort of magnetisable particles and/ or of the at least one further sort of magnetisable particles is thereby between 5 nm and 10 mm, preferably between 10 nm and 1 mm. The mixing ratio of the two sorts of magnetisable particles is variable within a wide range and can be coordinated to the respective special purpose of use. Thus the volume ratio of the first sort of magnetisable particles and of the at least one further sort of magnetisable particles relative to each other is between 1:99 and 99:1, preferably between 10:90 and 90:10.

The totality of the magnetisable particles, i.e. first and also further sort, relative to 100% by volume of the magnetorheological material, is thereby advantageously between 1 and 70% by volume, preferably between 10 and 50% by volume.

In particular, it proves to be advantageous if the first sort of magnetisable particles and/or the at least one further sort of magnetisable particles are present as mixtures of particles with a different particle size. It is thereby particularly preferred if the mixture is a bi- or trimodal particle size distribution. The first sort of magnetisable particles and/or the at least one further sort of magnetisable particles can thereby be distributed both anisotropically and isotropically in the carrier medium. An anisotropic distribution, by way of example, provides that the magnetisable particles are distributed in the shape of a chain. This can be effected for example in that, in the shaping process (this is for example crosslinking with elastomeric materials or cooling of a thermoplastic-elastomeric material), an external magnetic field is applied. The magnetic particles are thereby distributed along the field lines. As a result of the strength of the magnetic field prevailing during the crosslinking, the impressed microstructure can be influenced.

The basic rigidity of the elastomer composite without a magnetic field can be influenced by the selected elastomer material (polymer composition, chain length etc.) and also by the magnetic particles. The influence of the magnetic particles on the basic rigidity of the elastomer composite depends upon the volume concentration but also upon the type of particles, the particle size distribution and the particle shape. A further possibility for influencing is produced in addition by the use of plasticisers, such as for example poorly volatile oils. This opens up the possibility of producing extremely soft elastomer composites, as a result of which higher increase factors in the mechanical properties can be achieved. These correlations are already known. What is new is the possibility of producing, by the use of hard magnetic particles in the composite, a magnetisation which can be varied by a sufficiently strong magnetic field and remains constant after switching off the magnetic field and mechanical properties of the composite material which are variable therewith.

The carrier medium is thereby distinguished preferably by a shear modulus <500 kPa, preferably <250 kPa, particularly preferred <100 kPa, measured at 10 Hz and a deformation of 1%, and also by a Shore hardness A <20, preferably <10. Equally, it is preferred if the carrier medium has a modulus of elasticity <1500 kPa, preferably <750 kPa, particularly preferred <300 kPa.

There are possible as preferred materials for the carrier medium, in particular castable elastomer materials, such as silicones, polyurethanes and/or styrene block copolymers, e.g. styrene-olefin block copolymers, in particular styrene-ethylene-butylene block copolymers, styrene-ethylene-propylene block copolymers and/or polynorbornenes.

The rheological properties or further mechanical properties of the carrier material can be influenced positively in particular by the addition of additives, such as for example dispersion agents, antioxidants, defoamers and/or antiwear agents.

The addition of further additives is likewise possible, for example inorganic particles, such as SiO₂, TiO₂, iron oxides, sheet silicates or organic additives, and also combinations thereof.

Furthermore, additives can likewise be contained, such as for example additives for reducing abrasion phenomena, particulate supplements, such as graphite, perfluoroethylene or molybdenum compounds, such as molybdenum disulphite and also combinations thereof.

However, as alternatives hereto, likewise additives are possible for use for the surface treatment of workpieces, abrasively acting and/or chemically etching supplements, such as e.g. corundum, cerium oxides, silicon carbide and/or diamond.

In particular, a plasticiser is added to the magnetorheological material, which plasticiser is contained particularly advantageously in a quantity of at least 10% by weight, preferably 30% by weight, relative to the carrier medium. The plasticiser can thereby also make up 200% by weight of the carrier medium, as a result of which exceptionally soft elastomer- or thermoplastic-elastomer matrices are obtainable. Preferably, the plasticiser is selected from paraffinic and/or naphthenic oil and/or silicone oil.

A basic formula of the magnetorheological material is indicated in the following. Thereby
the proportion of magnetisable particles is between 1 and 70% by volume, preferably between 10 and 50% by volume,
the proportion of the carrier medium including plasticiser is between 30 and 99% by volume, preferably between 40 and 90% by volume,
the proportion of the additives is between 0.001 and 20% by mass, preferably between 0.01 and 15% by mass, relative to the magnetisable solids

According to the invention, a method for producing a magnetorheological material is likewise made available. The method is thereby distinguished in that at least one precursor of an elastomeric material and/or a thermoplastic-elastic material is mixed at least with the first sort of magnetisable particles and subsequently a composite of the magnetorheological material is produced by chemical and/or physical crosslinking. There are thereby understood by precursors of elastomers, for example materials from the group of polydimethylsiloxanes with vinyl groups or polyols which then react respectively with crosslinking partners.

Preferably, a magnetic field can be applied before and/or during the composite production, it being able to be achieved that an anisotropic distribution of the magnetisable particles along the field lines is obtained.

Furthermore, it is preferred that in addition at least one solvent selected from the group consisting of toluene, hydrocarbons, acetone is added during mixing. The solvent is advantageously evaporated again in a further step.

Furthermore, the plasticiser and/or the further sort of magnetisable soft magnetic particles are likewise added during mixing.

Furthermore, it is preferred if a chemical crosslinking of the at least one carrier medium is effected in the case of elastomers during the composite production. This can be effected for example by a temperature or heat treatment. Likewise, the sole or additional addition of crosslinking chemicals, e.g. isocyanates or polysiloxanes with contained Si—H groups for the crosslinking is also conceivable.

Preferred temperature ranges during the heat treatment are thereby between 25 to 150° C., preferably between 25 and 100° C. These temperatures are preferably maintained over a time duration between 1 s and 10 h.

The crosslinking of thermoplastic elastomers as carrier medium is effected simply by cooling the obtained composite, the matrix solidifying. In particular, this is effected at temperatures between 25 and 150° C., preferably at 30 to 100° C.

Furthermore, it is also possible that, during and/or subsequent to the composite production, shaping is effected, for example by extrusion, injection moulding or casting. Hence the magnetorheological composite materials can be brought into any shape.

It is preferred in particular if, during the composite production, adjustment of the operating point of the rigidity of the magnetorheological composite is effected by selection of the concentration of the at least one first sort of magnetisable particles and/or possibly the selection of the mixing ratio of the at least one first sort of magnetisable particles and of the at least one further sort of magnetisable particles.

It was established that, with the elastomer composites according to the invention, both the storage modulus (describes the elastic behaviour or energy storage) and the loss modulus (describes the viscous behaviour or energy dissipation) are influenced by the magnetic field. The same applies also for the loss factor as a ratio of loss- and storage modulus. All these properties are influenced remanently by the hard magnetic particles and reversibly by the soft magnetic particles. Hence technically significant possibilities for controlled vibration damping or vibration insulation are therewith produced.

A further possibility of the elastomer composites according to the invention with mixtures of hard magnetic and soft magnetic particles resides in the fact that, during a prescribed magnetisation of the hard magnetic particles by a previously applied strong magnetic field, the magnetisation of the soft magnetic particles by a subsequently applied weaker magnetic field which does not influence the magnetisation of the hard magnetic particles either strengthens or weakens the original magnetisation of the composite according to the direction of the weaker magnetic field. Correspondingly, also the mechanical properties of the elastomer composite according to the invention can be either increased or reduced with hard magnetic and soft magnetic particles, such as modulus of elasticity or shear modulus, as a function of the field direction. An increased basic rigidity of the elastomer composite can be set by the premagnetisation. The subsequently applied weaker magnetic field can either strengthen or weaken the magnetic field produced by the hard magnetic particles according to the direction and hence can either increase or reduce the rigidity of the elastomer composite (modulus of elasticity or shear modulus). With the premagnetisation, for example the operating point of the rigidity can be established in a vibration-reducing system.

An additional property of the magnetorheological elastomer composite resides in the occurrence of a shape memory effect. In the rigid state of the composite, an object formed from the composite material can be deformed by the effect of external forces. The rigid state can be achieved either by a remanent magnetisation of hard magnetic particles or by a mixture of hard magnetic and soft magnetic particles in the elastomer matrix. After the demagnetisation, the object returns to its original shape. This effect can be attributed to the fact that, in the magnetised state, the magnetic forces dominate between the particles, whilst the behaviour without magnetisation is determined by the elastic forces of the elastomer. A precondition for this resides in the fact that the elastic forces are not too strong. A soft elastomer matrix is therefore particularly advantageous. The described behaviour can be used for safety systems or artificial muscles.

Far-reaching possibilities for application result from the versatility of the magnetorheological elastomer composites according to the invention. The following possibilities for application in this respect may be cited by way of example in points:
in adaptive impact and vibration dampers, vibration insulators, controllable brakes, clutches, actuators, safety switches, haptic systems, artificial muscles and also in sports or training apparatus,
for surface machining of workpieces,
for producing and/or displaying haptic information, such as characters, computer-simulated objects, sensor signals or pictures; for simulating viscous, elastic and/or viscoelastic properties or for consistency distribution of an object, in particular for training and/or research purposes and/or for medical applications,
as magnetically controllable elastomer composites together with a magnetic circuit, which contains electromagnets and permanent magnets for setting the operating point of the rigidity.

### EMBODIMENT 1

Magnetorheological elastomer, consisting of a thermoplastic elastomer, 90% plasticiser, relative to the thermoplastic elastomer, and 30% by volume hard magnetic particles.

12 g granulate (styrene-ethylene-propylene block copolymer, density 0.89 g/cm³, HTP 8534/11, Thermolast K, Kraiburg TPE GmbH) are placed with 10.8 g paraffin low-viscous Ph Eur, BP, NF (density 0.85 g/cm³, Merck) and with 83.057 g hard magnetic powder MQP-S-119 (density 7.4 g/cm³, Magnequench, average particle size 45 μm) into a glass beaker and mixed with a spatula. Subsequently, 26 g toluene are added and mixed. The mixture is heated in an oven at 90° C. and agitated thoroughly every 5-10 minutes, as a result of which the dissolution of the polymer is accelerated and the evaporation of the toluene is promoted. After thickening of the mass, the latter is agitated every 15 minutes until the toluene has completely evaporated. The mixture is subsequently processed with an injection moulding tool. In this way, plate-shaped samples with a thickness of 1 mm are produced.

### EMBODIMENT 2

Magnetorheological elastomer, consisting of a thermoplastic elastomer, 90% plasticiser, relative to the thermoplastic elastomer, and 10% by volume hard magnetic particles and also 20% by volume soft magnetic particles.

12 g granulate (styrene-ethylene-propylene block copolymer, density 0.89 g/cm³, HTP 8534/11, Thermolast K, Kraiburg TPE GmbH) are placed with 10.8 g paraffin low-viscous Ph Eur, BP, NF (density 0.85 g/cm³, Merck), with 27.685 g hard magnetic powder MQP-S-119 (density 7.4 g/cm³, average particle size 45 μm, Magnequench) and with 58.491 g soft magnetic powder (carbonyliron SQ, density 7.817 g/cm³, average particle size 5 pm, BASF) in a glass beaker and mixed with a spatula. Subsequently 26 g toluene are added and mixed. The mixture is heated in air oven at 90° C. and agitated thoroughly every 5-10 minutes, as a result of which the dissolution of the polymer is accelerated and the evaporation of the toluene is promoted. After thickening of the mass, the latter is agitated every 15 minutes until the toluene has completely evaporated. The mixture is subsequently processed with an injection moulding tool. In this way, plate-shaped samples with a thickness of 1 mm are produced.

1-42. (canceled)

43. Magnetorheological materials, comprising at least one non-magnetisable elastomeric and/or thermoplastic-elastic carrier medium and magnetisable particles contained therein, characterised in that at least one first sort of magnetisable particles made of at least one hard magnetic material and at least one further sort of magnetisable particles made of at least one soft magnetic material are contained.

44. Magnetorheological materials according to claim 43, characterised in that the remanence Bᵣ of the at least one hard magnetic material is at least 50 mT, preferably at least 150 mT, particularly preferred at least 350 mT.

45. Magnetorheological materials according to claim 43, characterised in that at least one hard magnetic material is selected from the group consisting of alloys based on Al—Ni—Co, Al—Ni—Co—Fe—Ti, Cr—Fe—Co, Fe—Co—V—Cr, Pt—Co, Cu—Ni—Fe, rare-earth compounds, such as RE-Co, RE-Fe—B, RE-Fe—N, RE=Sm, Ce, Pr, Nd and/or Dy, e.g. Nd—Fe—B, Nd—Pr—Fe—Co—Ti—Zr—B, Pr—Fe—Co—Nd—B, Sm—Fe—N; hard ferrites, preferably according to the formula M¹O.n Fe₂O₃, M¹=Ba, Sr and/or Pb and preferably 4.5≦n=6.5 and also mixtures and/or alloys hereof.

46. Magnetorheological materials according to claim 43, characterised in that at least one further sort of magnetisable particles is contained.

47. Magnetorheological materials according to claim 43, characterised in that at least one soft magnetic material is selected from the group consisting of iron, cobalt, nickel (also in an impure form) and alloys thereof, such as iron-cobalt, iron-nickel; magnetic steel; iron-silicon and/or mixtures thereof.

48. Magnetorheological materials according to claim 43, characterised in that at least one soft magnetic material is selected from soft magnetic oxide-ceramic materials, in particular from cubic ferrites, perovskites and garnets of the general formula
M²O.Fe₂O₃
having one or more metals from the group M²=Mn, Fe, Co, Ni, Cu, Zn, Ti, Cd or Mg and/or mixtures thereof.

49. Magnetorheological materials according to claim 43, characterised in that at least one soft magnetic material is selected from the group consisting of mixed ferrites, such as Mn—Zn—, Ni—Zn—, Ni—Co—, Ni—Cu—Co—, Ni—Mg—, Cu—Mg ferrites and/or mixtures thereof.

50. Magnetorheological materials according to claim 43, characterised in that at least one soft magnetic material is selected from the group consisting of iron carbide or iron nitride, and also from alloys of vanadium, tungsten, copper and manganese and/or mixtures thereof.

51. Magnetorheological materials according to claim 43, characterised in that the soft magnetic materials are present in pure form, impure form and/or as mixtures thereof.

52. Magnetorheological materials according to claim 43, characterised in that the average particle size of the magnetisable particles is between 5 nm and 10 mm, preferably between 10 nm and 1 mm.

53. Magnetorheological materials according to claim 43, characterised in that the volume ratio of the first sort of magnetisable particles and of the at least one further sort of magnetisable particles relative to each other is between 1:99 and 99:1, preferably between 10:90 and 90:10.

54. Magnetorheological materials according to claim 43, characterised in that the total solids content of magnetisable particles, relative to 100% by volume, is between 1 and 70% by volume, preferably between 10 and 50% by volume.

55. Magnetorheological materials according to claim 43, characterised in that the first sort of magnetisable particles and/or the at least one further sort of magnetisable particles are present as mixtures of particles with a different particle size.

56. Magnetorheological materials according to claim 55, characterised in that mixture is a bi- or trimodal particle size distribution.

57. Magnetorheological materials according to claim 55, characterised in that the first sort of magnetisable particles and/or the at least one further sort of magnetisable particles have an anisotropic distribution in the at least one carrier medium.

58. Magnetorheological materials according to claim 43, characterised in that the first sort of magnetisable particles and/or the at least one further sort of magnetisable particles have an isotropic distribution in the at least one carrier medium.

59. Magnetorheological materials according to claim 43, characterised in that the at least one carrier medium has a shear modulus <500 kPa, preferably <250 kPa, particularly preferred <100 kPa, measured at 10 Hz and a deformation of 1%.

60. Magnetorheological materials according to claim 43, characterised in that the at least one carrier medium has a Shore hardness A <20, preferably <10.

61. Magnetorheological materials according to claim 43, characterised in that the at least one carrier medium has a modulus of elasticity <1500 kPa, preferably <750 kPa, particularly preferred <300 kPa.

62. Magnetorheological materials according to claim 43, characterised in that the at least one elastomeric and/or thermoplastic-elastomeric carrier medium is selected from the group consisting of silicones, polyurethanes and/or styrene block copolymers, e.g. styrene-olefin block copolymers, in particular styrene-ethylene-butylene block copolymers, styrene-ethylene-propylene block copolymers and/or polynorbornenes.

63. Magnetorheological materials according to claim 43, characterised in that they contain as additives, dispersion agents, antioxidants, defoamers and/or antiwear agents.

64. Magnetorheological materials according to claim 43, characterised in that they contain as further additives for reducing abrasion phenomena, particulate supplements, such as graphite, perfluoroethylene or molybdenum compounds, such as molybdenum disulphite and also combinations thereof.

65. Magnetorheological materials according to one of the preceding claims, characterised in that they contain as further additives for use for the surface treatment of workpieces, abrasively acting and/or chemically etching supplements, such as e.g. corundum, cerium oxides, silicon carbide and/or diamond.

66. Magnetorheological materials according to claim 43, characterised in that they contain at least 10% by weight, preferably 30 to 200% by weight, plasticisers, relative to the carrier medium.

67. Magnetorheological materials according to claim 66, characterised in that the plasticiser is selected from paraffinic and/or naphthenic oil and/or silicone oil.

68. Magnetorheological materials according to claim 43, characterised in that
the proportion of magnetisable particles is between 1 and 70% by volume, preferably between 10 and 50% by volume,
the proportion of the carrier medium including plasticisers is between 30 and 99% by volume, preferably between 40 and 90% by volume,
the proportion of the additives is between 0.001 and 20% by mass, preferably between 0.01 and 15% by mass, relative to the magnetisable solids.

69. Method for producing magnetorheological materials according to claim 43, characterised in that at least one precursor of an elastomeric material and/or a thermoplastic-elastic material is mixed at least with the first sort of magnetisable particles and subsequently a composite of the magnetorheological material is produced by chemical and/or physical crosslinking.

70. Method according to claim 69, characterised in that a magnetic field is applied before and/or during the composite production.

71. Method according to claim 69, characterised in that in addition at least one solvent selected from the group consisting of toluene, hydrocarbons, acetone is added during mixing.

72. Method according to claim 71, characterised in that at least one solvent is evaporated after conclusion of the mixing.

73. Method according to claim 69, characterised in that in addition the at least one plasticiser is added during mixing.

74. Method according to claim 69, characterised in that the at least one further sort of magnetisable particles consisting of soft magnetic materials is added during mixing.

75. Method according to claim 69, characterised in that the chemical crosslinking is effected by temperature increase to temperatures in the range of 25 to 150° C., preferably in the range of 25 to 100° C.

76. Method according to claim 75, characterised in that the temperature impingement is effected over a period of time between 1 s and 10 h.

77. Method according to claim 69, characterised in that the physical crosslinking is effected by temperature reduction to temperatures in the range of 25 to 150° C., preferably in the range of 30 to 100° C.

78. Method according to claim 69, characterised in that, during and/or subsequent to the composite production, shaping is effected, for example by extrusion, injection moulding or casting.

79. Method according to claim 69, characterised in that, during the composite production, setting of the operating point of the rigidity of the magnetorheological composite is effected by selection of the concentration of the at least one first sort of magnetisable particles and/or possibly the selection of the mixing ratio of the at least one first sort of magnetisable particles and of the at least one further sort of magnetisable particles.

80. Adaptive impact and vibration dampers, vibration insulators, controllable brakes, clutches, actuators, safety switches, haptic systems, artificial muscles or sports or training apparatus comprising magnetorheological materials of claim 43.

81. Method for surface machining of workpieces comprising using magnetorheological materials of claim 43.

82. Method for producing and/or displaying haptic information, such as characters, computer-simulated objects, sensor signals or pictures; for simulating viscous, elastic and/or viscoelastic properties or for consistency distribution of an object, in particular for training and/or research purposes and/or for medical applications comprising magnetorheological materials of claim 43.

83. Magnetically controllable elastomer composites together with a magnetic circuit, which contains electromagnets and permanent magnets for setting the operating point of the rigidity comprising magnetorheological materials according to claim 43.
